(19) United States
(12) Patent Application Publication
(10) Pub. No.: US 2012/0223525 A1
(43) Pub. Date: Sep. 6, 2012

(54) ELECTRICITY GENERATING DEVICE

(75) Inventor: MING-CHANG LEE, Tu-Cheng (TW)

(73) Assignee: HON HAI PRECISION INDUSTRY CO., LTD., Tu-Cheng (TW)

(21) Appl. No.: 13/076,448

(22) Filed: Mar. 31, 2011

(30) Foreign Application Priority Data
Mar. 1, 2011 (TW) 100106689

(51) Int. Cl. H02K 7/18; H02K 7/108

(52) U.S. Cl. 290/52; 290/1 C

(57) ABSTRACT

An electricity generating device includes a generator, a counterweight flywheel, and a power transfer equipment. The counterweight flywheel includes a flywheel body connected to the generator, a clutch set on the flywheel body and a number of weight bodies movably attached to the flywheel body. The power transfer equipment is to drive the flywheel to rotate via the clutch, and in turn, the flywheel body is to drive the generator to generate electricity.

### BACKGROUND

1. Technical Field

The present disclosure relates to an electricity generating device.

2. Description of Related Art

With advances in automotive technology, cars need to use more and more electrical power. A generator is installed in a car as the main electrical power source. The generator is connected to the engine of the car. The car is driven to move by the engine. Sometimes, the speed of the car changes, correspondingly, power output of the engine changes too. However, the change in power output of the engine will affect the stability of the generator as it generates electricity.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of a first exemplary embodiment of an electricity generating device, the electricity generating device includes a counterweight flywheel.

FIG. 2 is a schematic, top plan view of the counterweight flywheel of FIG. 1, showing a state of non-rotation, when the counterweight flywheel is flat placed.

FIG. 3 is a schematic, side plan view of the counterweight flywheel of FIG. 1, showing a state of rotation.

FIG. 4 is a schematic view of a second exemplary embodiment of an electricity generating device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

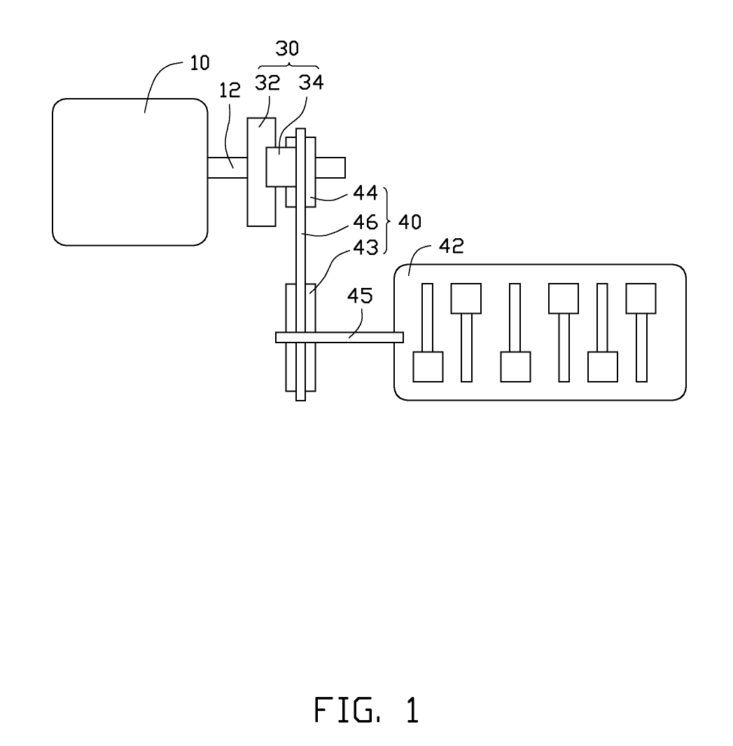

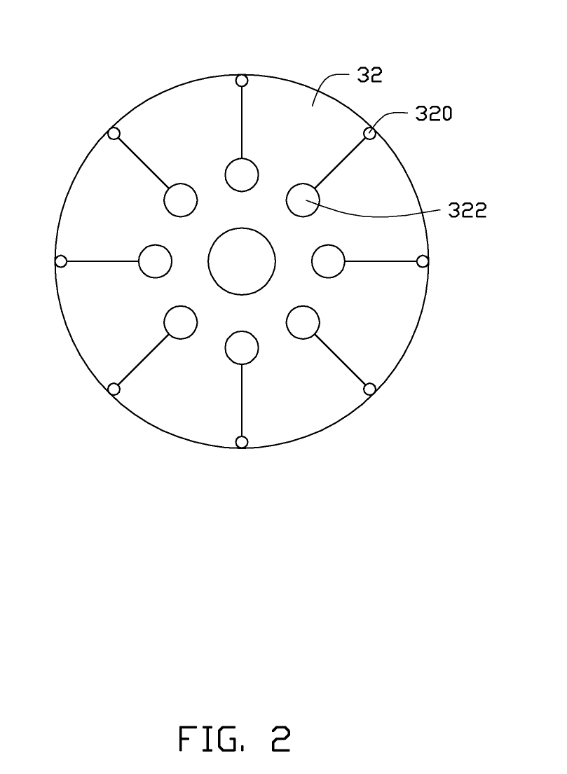

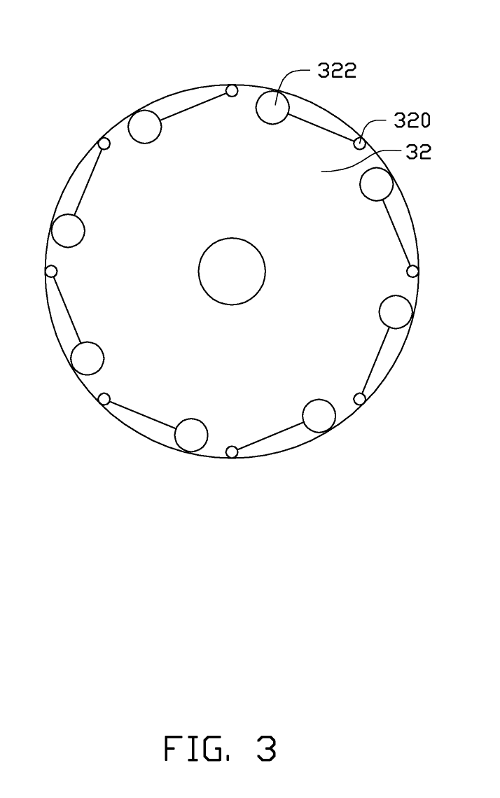

Referring to FIGS. 1 to 3, a first exemplary embodiment of an electricity generating device includes a generator 10, a counterweight flywheel 30 and a power transfer equipment 40.

The counterweight flywheel 30 includes a flywheel body 32 connected to a shaft 12 of the generator 10, and a clutch 34 installed on the flywheel body 32. The flywheel body 32 includes a plurality of elastic elements 320 and a plurality of spherical weight bodies 322 each connected to a corresponding one of the elastic elements 320. The weight bodies 322 can increase the inertia of the flywheel body 32. The weight bodies 322 connected to the elastic elements 320 can reduce extra physical strength that starts the flywheel body 32. In this embodiment, each elastic element 320 is a spring.

The power transfer equipment 40 includes a first wheel 43 connected to a shaft 45 of a power equipment 42, a second wheel 44 connected to the clutch 34, and a belt 46 fitting about the first and second wheels 43 and 44 to transfer rotation from the first wheel 43 to the second wheel 44. In this embodiment, the power equipment 42 is a car engine. In another embodiment, the power equipment 42 can be an engine of a high-torque device, such as an injection molding machine, a stamping machine, an air compressor, or a cold compressor.

In use, the power equipment 42 rotates, the rotating power of the power equipment 42 is transferred to the flywheel body 32, the flywheel body 32 drives the generator 10 to rotate to generate electricity. When the speed of the power equipment 42 changes, the flywheel body 32 can allow the generator 10 to stably generate electricity because of the inertia of the flywheel body 32.

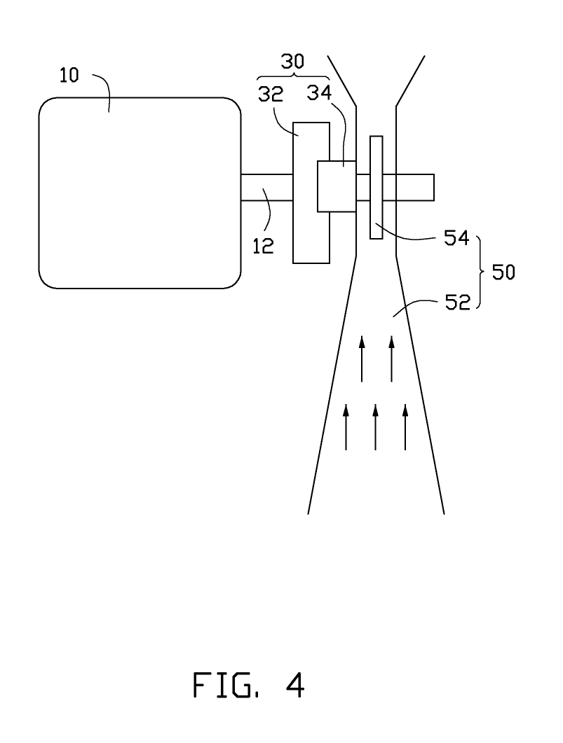

Referring to FIG. 4, a second exemplary embodiment of an electricity generating device includes a generator 10, a counterweight flywheel 30, and a power transfer equipment 50. The generator 10 and the counterweight flywheel 30 in this embodiment are similar to the generator 10 and the counterweight flywheel 30 in the first embodiment. The power transfer equipment 50 includes an exhaust pipe 52 of a car and an impeller 54 arranged in the exhaust pipe 52. The counterweight flywheel 30 includes a flywheel body 32 connected to a shaft 12 of the generator 10, and a clutch 34 installed to the flywheel body 32. The impeller 54 is connected to the clutch 34. When the car runs, gas is exhausted through the exhaust pipe 52. The gas drives the impeller 54 to rotate. The impeller 54 makes the flywheel body 32 rotate to drive the generator 10 to rotate and generate electricity. When the gas displacement changes, the flywheel body 32 can make the generator 10 stably generate electricity because of the inertia of the flywheel body 32.

In another embodiment, the exhaust pipe 52 can be replaced by a blower defined in a front of the car. When the car moves, wind enters the blower to drive the impeller 54 to rotate.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

1. An electricity generating device comprising:
a generator comprising a shaft;
a counterweight flywheel comprising a flywheel body connected to the shaft of the generator, a clutch set on the flywheel body, and a plurality of weight bodies movably attached to the flywheel body; and
a power transfer equipment connected to the clutch;
wherein the power transfer equipment transfers is to drive the flywheel to rotate via the clutch, and in turn, the flywheel body is to drive the generator to generate electricity.

2. The electricity generating device of claim 1, wherein the power transfer equipment comprises a first wheel connected to a power equipment of the power transfer equipment, a second wheel connected to the clutch, and a belt fitting about the first and second wheels to transfer rotation from the first wheel to the second wheel.

3. The electricity generating device of claim 1, wherein the power transfer equipment comprises an exhaust pipe and an impeller arranged in the exhaust pipe, the impeller is connected to the clutch to rotate the flywheel.

4. The electricity generating device of claim 1, wherein the plurality of weight bodies is spherical.

5. The electricity generating device of claim 1, wherein each weight body is attached to the flywheel body by an elastic member.

6. The electricity generating device of claim 5, wherein the elastic member is a spring.
